(19) United States
(12) Patent Application Publication
(10) Pub. No.: US 2014/0025691 A1
(43) Pub. Date: Jan. 23, 2014

(54) METHOD AND APPARATUS FOR DYNAMIC FILTERING OF AN OBJECT GRAPH IN A CONTENT REPOSITORY

(71) Applicants: Akhil Kumar Jain, Chandni Chowk (IN); Amit Jain, Bangalore (IN)

(72) Inventors: Akhil Kumar Jain, Chandni Chowk (IN); Amit Jain, Bangalore (IN)

(73) Assignee: Adobe Systems Inc., San Jose, CA (US)

(21) Appl. No.: 13/554,023

(22) Filed: Jul. 20, 2012

(51) Int. Cl. G06F 17/30

(52) U.S. Cl. 707/754; 707/E17.011

(57) ABSTRACT

A method and apparatus for dynamic filtering of an object graph in a content repository. The method comprises accessing a plurality of objects in an object graph of a content repository; forming a request using at least one filtering expression, wherein the filtering expression is used to perform an operation on a selected subset of objects in the object graph; and executing the request on the selected subset of objects, using the at least one filtering expression.

### BACKGROUND OF THE INVENTION

1. Field of the Invention

Embodiments of the present invention generally relate to managing operations pertaining to a content repository and, more particularly, to a method and apparatus for dynamic filtering of an object graph in a content repository.

2. Description of the Related Art

A Java Content Repository (JCR) is a specification that specifies the application programming interfaces (APIs) that can be used for accessing a content repository. A programming construct that combines hierarchical data with a set of methods for storing, accessing and managing those data is known as an object. In a content repository, digital content is stored with an associated set of data management, search and access methods allowing application-independent access to the content, similar to a digital library, but with the ability to store and modify content in addition to searching and retrieving. Objects are one type of digital data stored in the content repository. An object typically defines an instance of a class. For example, an object class may be “Employee”. The attributes of the class Employee may be “start date”, “position”, “salary”, “address”, and the like. An object “John Smith” may be an instance of the class Employee and may be connected to other Employee objects associated with a number of employees who work for John Smith. Each instance of Employee is an object and each instance of an employee working for John Smith may be created as Employee objects associated with the John Smith object, each additional object comprising attributes of its own. An object is represented as a node in the content repository. To form an object graph, the objects are linked to each other by one object either owning or containing another object or holding a reference to another object. This web of linked objects is known as an object graph and is a view of a content repository at a particular point in time.

When an operation is performed on an object, the operation is performed on the object as a whole. For example, when an Employee object has a change in the “salary” attribute, the entire Employee object is retrieved, the salary attribute is updated, and the entire Employee object is stored. In some instances, the operation is performed on the object graph as a whole. Due to the size of an object graph, performing operations on the object or on the object graph as a whole results in poor overall performance of the system and wasted memory. It is desirable to operate on a subset of objects (i.e., only a part of an object graph), or to operate on a subset of the attributes of an object.

In addition to operating on specific attributes of objects or just a part of the object graph, a user may wish to operate on objects that have specific relationships between them. A relationship may be direct (i.e., a→b), where a is a source object and b is a target object. Other relationships include transitive (i.e., a→b→c→ . . . ), direct relationships through an object (i.e., a→b→alldirectof<b>), all relationships at any level through a related object (i.e., a→b→allrelationsatalllevelsof<b>), recursive relations starting at a path and the recursion path (i.e., a→b→c where recursion starting at c if c is c′ (a subclass of c) through path c′→d→c or if c is c″(subclass of c) through path c″→e→f→c and so on) and all potential combinations thereof.

Thus, there is a need for a method and apparatus for dynamic filtering of an object graph in a content repository.

### SUMMARY

Embodiments of the invention generally relate to method and apparatus for dynamic filtering of an object graph in a content repository. The method and apparatus comprise accessing a plurality of objects in an object graph of a content repository. The method and apparatus form a request based on at least one filtering expression, wherein the filtering expression is used to perform an operation on a selected subset of objects in the object graph. The method and apparatus execute the request on the selected subset of objects in the content repository using the at least one filtering expression.

### BRIEF DESCRIPTION OF THE DRAWINGS

FIG. 1 depicts a block diagram of a system for dynamic filtering of an object graph in a content repository, according to one or more embodiments;

FIG. 2 is a flow diagram of a method for dynamic filtering of an object graph in the content repository, as performed by the object management module of FIG. 1, according to one or more embodiments;

FIG. 3 is a flow diagram of a method for retrieving related objects in a content repository, as performed by the object management module of FIG. 1, according to one or more embodiments; and

FIG. 4 depicts a computer system that can be utilized in various embodiments of the present invention, according to one or more embodiments.

While the method and apparatus is described herein by way of example for several embodiments and illustrative drawings, those skilled in the art will recognize that a method and apparatus for dynamic filtering of an object graph in a content repository is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of improved method and apparatus for dynamic filtering of an object graph in a content repository defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Embodiments of the present invention relate to a method and apparatus for dynamic filtering of an object graph in a content repository. In some embodiments, filtering expressions are defined to form a request for creating, updating and retrieving specific attributes of an object in an object graph in a content repository, upon execution of the request. In some embodiments, the filtering expressions are defined to form a request for performing these operations on a specific part of the object graph. In the embodiments, the method defines the filtering expressions using XML path language (XPATH). These filtering expressions are used with the create, update, and retrieve operations, to request a create, update, or retrieve operation on parts of the object graph based on the criteria defined in the filtering expression while ignoring parts of the object graph not defined in the filtering expression.

In other embodiments, relationships are defined between source and target objects in the content repository wherein the relationship can be direct, transitive, or recursive. The method comprises defining the relationship names or paths for retrieving the desired related objects from the content repository.

Advantageously, embodiments of the invention improved performance for large and complex objects by providing finer control over objects in order to limit the object graph while creating, updating and retrieving.

Various embodiments of improved method and apparatus for dynamic filtering of an object graph in a content repository are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

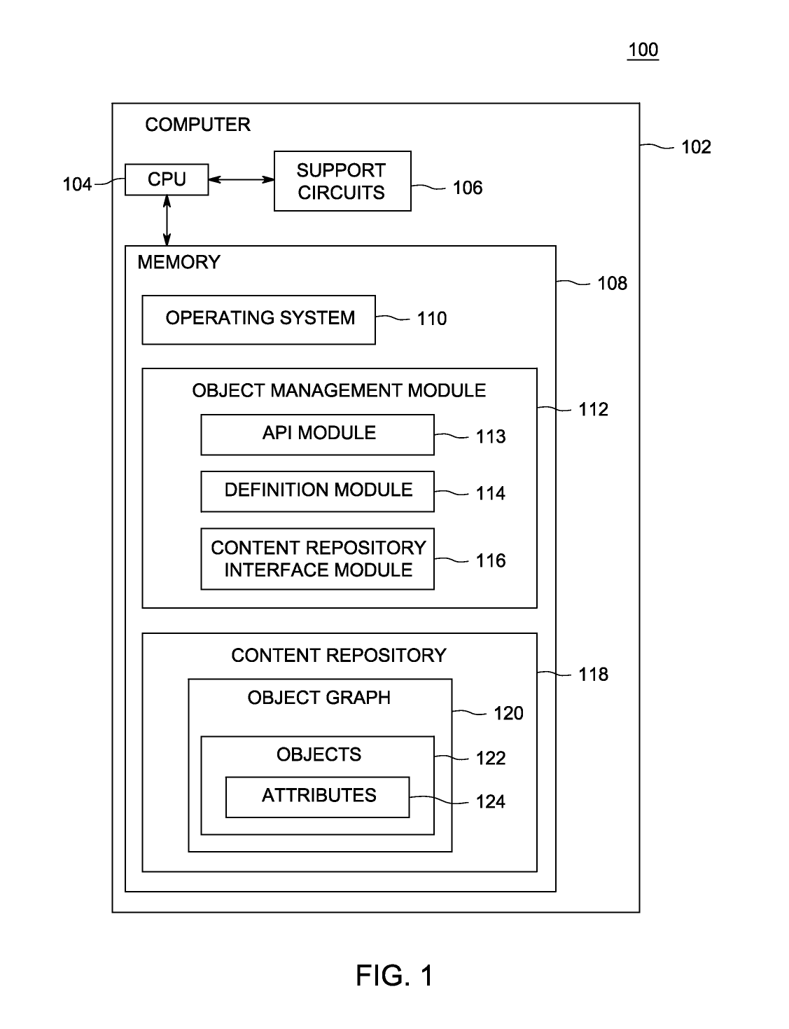

FIG. 1 depicts a block diagram of an system 100 for dynamic filtering of an object graph in a content repository, according to one or more embodiments. The system 100 comprises a computer 102. The computer 102 comprises a Central Processing Unit (CPU) 104, support circuits 106, and a memory 108. The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, and the like. The memory 108 comprises at least one of Read Only Memory (ROM), Random Access Memory (RAM), disk drive storage, optical storage, removable storage and/or the like. The memory 108 comprises an Operating System (OS) 110, an object management module 112 and a content repository 118. The object management module 112 comprises an application programming interface (API) module 113, a definition module 114 and a content repository interface module 116. The content repository 118 comprises an object graph 120. The object graph 120 comprises a plurality of objects 122. Each object in the plurality of objects 122 comprises a plurality of attributes 124.

The object management module 112 facilitates retrieving objects from an object graph of a Plain Old Java Object (POJO) persisted in the content repository 118. A persisted object is simply an object stored in the content repository rather than temporarily stored in memory. A persisted object remains stored after an application that created it terminates. The object management module 112 may be any object manager that allows for object relational mapping over a JCR-based content repository, such as ADOBE® LiveCycle inside Adobe's Correspondence Management Solution Accelerator.

The object management module 112 implements the definition module 114. The definition module 114 receives filtering expressions from a user input via the API module 113 for creating, updating and retrieving specific attributes 124 of objects 122 from an object graph 120 in the content repository 118. The defined filtering expressions are used to form requests to create, update and retrieve and dynamically filter the objects 122 created, updated and retrieved in the object graph 120 of the content repository 118. For example, a user may have an object of class Letter stored in the content repository 118. The object may be named “MyLetter” and may have attributes such as date, subject line, greeting, body of the letter, disclaimer, and closing. The user may want to update only the subject line of the letter. The definition module 114 creates a request to retrieve and update the subject line alone without retrieving the entire letter. To request and update the subject line alone, “MyLetter/subjectline” is passed in the retrieve call and update call.

XPATH query language provides a way to represent and define data in an Extensible Markup Language (XML) based on a hierarchical structure. XPATH style query language is used to represent objects, properties and relationships, while working with POJOs. By defining simple filtering criteria as expressions using XPATH style language construct and then passing the filtering criteria along with other relevant operations, the object graphs are filtered using the specified XPATH expressions. For example, the definition module 114 facilitates dynamically defining one or more properties of an object to be retrieved, created or updated; such as:
all the properties of the object to be retrieved, created or updated,
a complete object graph to be retrieved, created or updated;
one or more properties of the object if the object is of a specific subtype, as in the case of inheritance;
object relationships to be retrieved, created or updated; and
required or desired elements to be retrieved, created or updated in a related object using a similar style as specified in all of the above criteria.

The content repository interface module 116 retrieves the objects from the object graph in the content repository 118 based on expressions defined by the definition module 114.

In certain embodiments, the object management module 112 receives filtering expressions from a user input via the API module 113, wherein the filtering expressions are used to form retrieval requests based strictly on object relationships to dynamically filter the objects 122 in the object graph 120 of the content repository 118. From the previous example, a user may wish to delete some content from the letter, such as the disclaimer. However, the disclaimer may be related to several letters in the content repository. The disclaimer cannot simply be deleted because it is linked to other letters. The definition module 114 creates a request to remove the link between the letter and the disclaimer without affecting the links between other letters and the disclaimer. In order to update MyLetter to remove the disclaimer link, the user would remove the link and update MyLetter using “MyLetter/disclaimer” in the update call.

The content repository interface module 116 facilitates retrieval of transitive source and target relationships of a given object, as well as all direct source and target relationships of objects 122 in an object graph 120 through another related object 122 based on the filtering expression. Further, the content repository interface module 116 facilitates discovery of all source and target relationships of an object 122 through another object 122 at any level above/below a given relationship path and recursive source/target relationships of a given object 122, where a recursion path is specified.

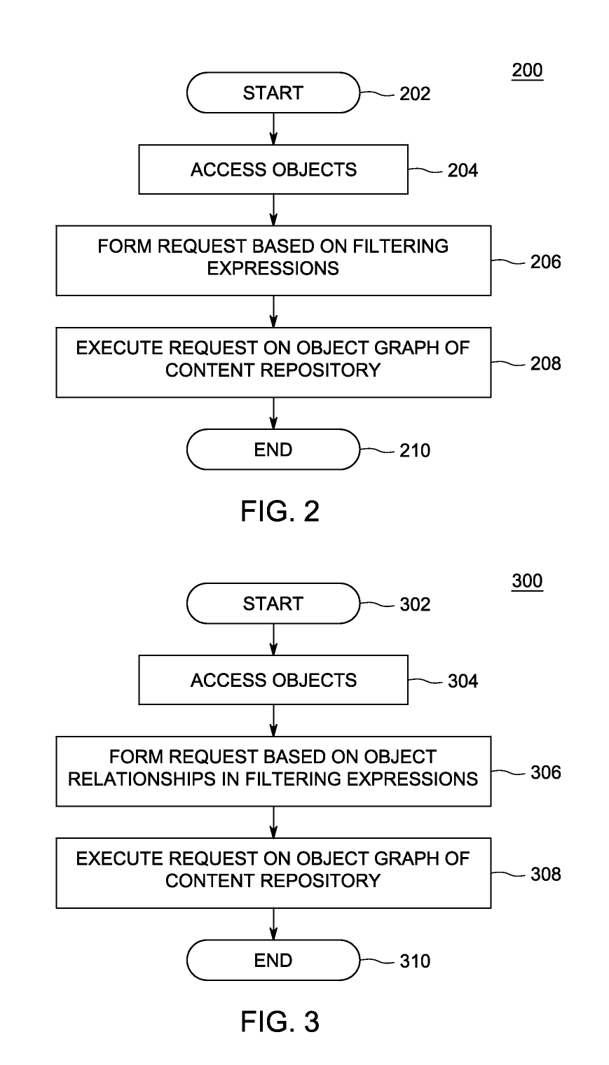

FIG. 2 is a flow diagram of a method 200 for dynamic filtering of an object graph in the content repository 118, as performed by the object management module 112 of FIG. 1, according to one or more embodiments.

The method 200 starts at step 202, and proceeds to step 204. At step 204, the method 200 accesses objects in an object graph.

The method 200 proceeds to step 206. At step 206, the method 200 forms a request based on filtering expressions received from a user input, wherein the filtering expression defines a subset of objects in an object graph or a subset of attributes of an object in an object graph on which to perform the requested operation.

The method 200 defines XPATH expressions in connection with object graph filtering using an XPATH style query language.

For example, consider the following JAVA Classes. These classes are purely used for illustration and are defined by a user prior to execution of method 200.

```
class Employee {
  String name;
  int age;
  float salary;
};
class ContractualEmployee extends Employee {
  int no_of_days;
};
class PermanentEmployee extends Employee {
  StringemployeeCode;
  Date joiningDate;
};
class Department {
  String name;
  String id; List<Employees> employees;
};
class Company {
  String name;
  String id; List<Department> departments;
  Employee ceo;
  Employee md;
}.
```

The class Employee is comprised of attributes name, age, and salary. Since an object is an instance of a class, a specific Employee, for example, John Smith, age 53, salary $100,000, is an example of an object. The class ContractualEmployee is a class based on the class Employee. The class ContractualEmployee comprises all of the attributes of the class Employee, and comprises the additional attribute “no of days”. Similarly, the class PermanentEmployee is a class based on the class Employee. The class Permanent Employee comprises all of the attributes of the class Employee, and further comprises the attributes employeeCode and joiningDate. The class Department is comprised of an ID and contains a list of Employee objects in that department. Lastly, class Company comprises attributes name, and id, and also comprises a list of department objects (of class Department), a ceo of class Employee, and an and of class Employee. The following examples describe XPATH expressions for filtering the objects in an object graph using the exemplary classes defined above. These example are purely illustrative.

In order to create, update or retrieve only the name of an employee while creating, updating or retrieving an Employee object, the method 200 forms a request using the XPATH expression “/Employee/name”. To create, update or retrieve only the name and ID number (id) of an employee while creating, updating or retrieving an Employee object, the method 200 forms a request using the XPATH expression “/Employee/name|/Employee/id”.

In another example, to create, update or retrieve all properties of an employee while creating, updating or retrieving an Employee object but do not create, update or retrieve any related objects, the method 200 forms a request using the XPATH expression “/Employee/*”. To create, update or retrieve name of a company and the name of all the departments of the company while creating, updating or retrieving a Company object, the method 200 forms a request using the XPATH expression “/Company/name|/Company/departments/name”.

To create, update or retrieve the name of a company, all properties of departments, all properties of the CEO (Chief Executive Officer) and only the name of the MD (Managing Director) while creating, updating or retrieving a Company object, the method 200 forms a request using the XPATH expression “/Company/name|/Company/departments/*|/Company/ceo/*|/Company/md/name”. To create, update or retrieve the name of a company and the complete object graph of departments while creating, updating or retrieving a Company object, the method 200 forms a request using the XPATH expression “/Company/name|/Company/departments//*”.

To create, update or retrieve the name of a Company, the name of the CEO, all departments, the name of all employees in the departments and their employeeCode if the department employee is Permanent (inheritance usage) while creating, updating or retrieving a Company object, the method 200 forms a request using the XPATH expression “/Company/name|/Company/ceo/name|/Company/departments/employees/name|/Company/departments/employees[PermanentEmployee]/employeeCode”. In order to create, update or retrieve a complete object graph of a company while creating, updating or retrieving a Company object, the method 200 forms a request using the XPATH expression “/Company//*”.

The method 200 proceeds to step 208. At step 208, the method 200 creates, updates or retrieves the desired objects based on the requests formed in step 206. The method 200 executes the request of step 206 based on the filtering expression thereby facilitating dynamic object graph filtering during the performance of these operations. Hence, only the subset of objects in an object graph specified in the filtering expression or a subset of attributes of an object specified in the filtering expression are acted upon while the remaining object graph is ignored. The method 200 proceeds to step 210 and ends.

FIG. 3 is a flow diagram of a method 300 for retrieving related objects in a content repository 118, as performed by the object management module 112 of FIG. 1, according to one or more embodiments of the invention. The method 300 retrieves objects based on specified relationships between objects.

The method 300, according to one embodiment, facilitates selectively retrieving relationships of an object in an object graph in the content repository. Objects in an object graph in a content repository may be direct, transitive and/or recursive relationships. Relationship paths can be constructed using the name of a relationship source or target class and the property names that link the class to the relationship target or source class. For example, if a Class A has a reference ‘b’ to Class B, the relationship between A and B is defined as Nb. Similarly, if there are intermediate objects between a relationship source and target, the relationship path can have intermediate property names, for example, relation path A/b/c will retrieve all objects of type C related to A (via B) where the object structure is A→b(B) and B→c(C) (i.e., A refers to B as b and B refers to C as c.) Special character ‘*’ can be used to specify a wildcard relationship search i.e, to retrieve all relationships that are pointed to be the relationship path. For example, ‘*’ as a relationship path refers to all direction relations, while <rel_path_str>/* refers to all direct relations below a specified relationship path (for target relations) or above the specified relationship path (for source relations). Similarly, <rel_path_str>//* refers to all relations at any level below the specified relationship path (for target relations) or above the specified relationship path (for source relations). Object relationships that have recursive cycles may be searched beginning at the relationship target if the recursion break points are known by specifying the relationship path from source to target and also the recursion paths that begin at the target. Multiple relationships may be specified by separating the relationships through a ‘|’ operator. For example, two relationships, D and B from A, where the object structure is A→b(B), A→c(C), and C→d(D) (i.e., A refers to B as b and C as c and C refers to D as d). The relationship path is then “A/b|A/c/d”. The method 300 forms retrieval requests using one or more filtering expressions received from a user input, wherein the filtering expressions define a subset of objects in an object graph that possess direct, transitive, or recursive relationships. The method 300 executes the one or more XPATH style expressions and retrieves the related objects based on the request.

As used in the current description and context herein, the term “relationshipPath” refers to an XPATH expression specifying the relationship path. The term “is Source” refers to or implies whether a relationship source or target is required. The term “recursionPath” refers to an XPATH expression specifying path(s) where recursion starts. The term “cutpoints” refers to filters to be used while returning related objects.

The method 300 starts at step 302, and proceeds to step 304. At step 304, the method 300 accesses objects in an object graph. The method 300 proceeds to step 306.

At step 306, the method 300 forms a retrieval request based on filtering expressions received from a user input, wherein the filtering expression defines a relationship of a subset of objects in an object graph that are to be retrieved. The method 300 defines XPATH expressions in connection with object graph filtering using an XPATH style query language.

For example, consider the following JAVA Classes. These classes are purely used for illustration and are defined by a user prior to execution of method 300.

```
public class ClassA {
    private ClassB classB;
    private String testDataFileName;
    priviate Set<ClassC> setClassC;
    ...
}
public class ClassC {
    private String id;
    private boolean ordered;
    private ClassD classD;
    private List<ClassE> classEList;
    ...
}
public class ClassE {
    private ClassF classF;
    private String expression;
}
private class ListClassF extents ClassF {
    private List<ClassG> assignmentList;
    private int min;
    private int max;
    ...
}
public class ConditionalClassF extends ClassF {
    private List<ClassH> assignmentList;
    ...
}
public class ClassG {
    private Integer position;
    private boolean optional;
    private ClassF target;
    ...
}
public class ClassH {
    private Integer position;
    private String expression;
    private ClassF target;
    ...
}
public class ClassD {
    private String id;
    private String path;
    private String displayName;
    private Integer position;
    ...
}
public class TextgClassF extends ClassF {
    private String fileName;
    private byte[ ] TBXXMLBytes;
    ...
}
public class ImageClassF extends ClassF {
    private String fileName;
    private String caption;
    private byte[ ] imageBlob;
    ...
}
public class ClassB extends Asset {
    private String fileName;
    private boolean outboxEnabled;
    private Set<ClassD> setClassD;
    private Set<Field> fields;
    ...
}
```

The following examples describe XPATH expressions for filtering the objects in an object graph based on their relationship. These examples are purely illustrative.

For example, to find all data objects directly related to a ClassA object, where ClassA is a relationship source, the method 300 forms a request using the XPATH expression:

relationshipPath : ‘*’
isSource : true
Cutpoints : ‘ ’.

In order to find all objects directly related to a ClassB object, where ClassB is a relationship target, the method 300 forms a request using the XPATH expression:

relationshipPath : ‘*’
isSource : false
Cutpoints : ‘ ’.

In order to find all ClassB objects, with their properties, that are directly related to a ClassA object, where ClassA is a relationship source, the method 300 forms a request using the XPATH expression:

relationshipPath : ‘*’
isSource : true
Cutpoints : ‘ClassB/* ’.

In order to find all objects that are related to a ClassA object through any possible relationship path, where ClassA is a relationship source, the method 300 forms a request using the XPATH expression:

relationshipPath : ‘//*’
isSource : true
Cutpoints : ‘ ’.

In order to find all objects that are related to a TextClassF object through any possible relationship path, where TextClassF is a relationship target, the method 300 forms a request using the XPATH expression:

relationshipPath : ‘//*’
isSource : false
Cutpoints : ‘ ’.

In order to find all TextClassF objects, with their complete object graph, and all ImageClassF objects, with only fileName and caption properties, that are related to a ClassA object through any possible relationship path, where ClassA is a relationship source, the method 300 forms a request using the XPATH expression:

relationshipPath : ‘//*’
isSource : true
Cutpoints : ‘TextClassF//*|ImageClassF/filename|ImageClassF/caption’.

In order to find all TextClassF objects, with fileName property, that are related to a ClassA object through a relationship ClassA/setClassC/ClassEList/ClassF, where ClassA is a relationship source, the method 300 forms a request using the XPATH expression:

relationshipPath : ‘ClassA/setClassC/classEList/classF’
isSource : true
Cutpoints : ‘TextClassF/fileName’.

In order to find all ClassA objects that are related to a TextClassF object through a relationship ClassA/setClassC/classEList/classF, where TextClassF is a relationship target, the method 300 forms a request using the XPATH expression:

relationshipPath : ‘ClassA/setClassC/classEList/classF’
isSource : false
Cutpoints : ‘ ’.

In order to find all TextClassF objects, with all of their properties, that are related to a ClassA object through relationship ClassA/setClass/classEList/classF and a displayName of all ClassD objects, wherein the classD objects are related to a ClassA through a relationship ClassA/setClassC/ClassD, where ClassA is a relationship source, the method 300 forms a request using the XPATH expression:

```
      P10 relationshipPath:
‘ClassA/setClassC/classEList/classF|ClassA/setClassC/classD’
      P10 isSource : true
      P10 Cutpoints : ‘TextClassF/*|ClassD/displayName’.
```

In order to find all TextClassF objects, with fileName property, that are related to a ClassA object through any relationship path starting at ClassA/setClassC, where ClassA is a relationship source, the method 300 forms a request using the XPATH expression:

relationshipPath : ‘ClassA/setClassC//*’
isSource : true
Cutpoints : ‘TextClassF/fileName’.

In order to find all ClassA objects, with testDataFileName, related to a TextClassF object through any relationship path starting at ClassE/classF, where TextClassF is a relationship target, the method 300 forms a request using the XPATH expression:

relationshipPath : ‘classE/classF//*’
isSource : false
Cutpoints : ClassA/testDataFileName’.

In order to find all TextClassF objects, with fileName property, that are related to a ClassA object through any relationship path directly below ClassA/setClassC/classEList, where classA is a relationship source, the method 300 forms a request using the XPATH expression:

relationshipPath : ‘ClassA/setClassC/classEList/*’
isSource : true
Cutpoints : ‘TextClassF/fileName’.

In order to find all ClassA objects, with testDataFileName, related to a TextClassF object through any relationship directly above ClassE/classF, where TextClassF is a relationship target, the method 300 forms a request using the XPATH expression:

relationshipPath : ‘ClassC/classEList/class/*’
isSource : false
Cutpoints : ‘ClassA/testDataFileName’.

In order to find all TextClassF objects, with properties, that are related to a ClassA object through a relationship ClassA/setClassC/classEList/classF, where classF is a ListClassF object, then the method 300 recursively searches TextClassF objects in the path ListClassF/assignmentList/target, forming a request using the XPATH expression:

relationshipPath : ‘ClassA/setClassC/classEList/classF’
recursionPath : ListClassF/assignmentList/target
isSource : true
Cutpoints : ‘TextClassF/*.

Here, an endpoint of the relationship path classF is a starting point for recursion path ListClassF. Therefore, the starting point of the recursion path must be of a same type or subtype of the endpoint of the relationship path.

In order to find all TextClassF objects, with propertie, that are related to a ClassA object through a relationship ClassA/setClassC/classEList/classF, if classF is a ListClassF object, then the method 300 recursively searches TextClassF objects in the path ListClassF/assignmentList/target, or if classF is a ConditionalClassF object, then the method 300 recursively searches TextClassF objects in the path ConditionalClassF/assignmentList/target, wherein the method 300 forms a request using the XPATH expression:

```
        relationshipPath : ‘ClassA/setClassC/classEList/classF’
        recursionPath:
ListClassF/assignmentList/target|ConditionalClassF/assignmentList/target
        isSource : true
        Cutpoints : ‘TextClassF/*’.
```

Here, the end point of relationship path classF is the starting point for recursion path ListClassF and ConditionalClassF. The starting point of the recursion path must be a same type or subtype of the endpoint of the relationship path. At each recursion cycle, the obtained objects (target (ClassF)) are evaluated for the desired object (TextClassF) or for the next recursion cycle (ListClassF, ConditionalClassF). Multiple recursion paths may be specified separated by a ‘|’.

In order to find all ClassA objects, with properties, that are related to a TextClassF object through a relationship ClassA/setClassC/classEList/classF and also recurse in relationship path ListClassF/assignmentList/target while finding the ClassA object through the relationship path specified, the method 300 forms a request using the XPATH expression:

objectIdOrPath: Id or path of the TextClassF object
relationshipPath : ‘ClassA/setClassC/classEList/classF’
recursionPath : ListClassF/assignmentList/target
isSource : false
Cutpoints : ‘ClassA/*’.

Here, the target object (objectIdOrPath) is the starting point for a recursion path (target). The starting point of the recursion path must be a same type or supertype of the target object. At each recursion cycle, the objects found (ListClassF) are evaluated for the relationship path (ClassA/setClassC/classEList/classF) to get the source objects (ClassA) and are also evaluated for further recursion (satisfying ListClassF/assignmentList/target). Multiple recursion paths can be specified separated by a ‘|’.

In order to find all ClassA objects (with properties) that are related to a TextClassF through a relationship ClassA/setClassC/classEList/classF and also recurse in relationship path ListClassF/assignmentList/target or ConditionalClassF/assignmentList/target, while finding the ClassA object through the relationship path specified, the method 300 forms a request using the XPATH expression:

```
        objectIdOrPath: Id or path of the TextClass object
        relationshipPath : ‘ClassA/setClassC/classEList/classF’
        recursionPath
ListClassF/assignmentList/target|ConditionalClassF/assignmentList/target
        isSource : false
        Cutpoints : ‘ClassA/*’.
```

Here, the target object (objectIdOrPath) is the starting point for a recursion path (target). The starting point of the recursion path must be a same type or supertype of the target object. At each recursion cycle, the objects found (ListClassF, ConditionalClassF) are evaluated for the relationship path (ClassA/setClassC/classEList/classF) to get the source objects (ClassA) and are also evaluated for further recursion (satisfying ListClassF/assignmentList/target or conditionalClassF/assignmentList/target). Multiple recursion paths can be specified separated by a ‘|’.

The method 300 proceeds to step 308. At step 308, the method 300 retrieves the desired objects based on the requests formed in step 306 based on the relationship specified. The expressions allow retrieval of transitive source and target relationships of a given object and all direct source and target relationships of an object through another related object. The method 300 proceeds to step 310 and ends.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

### Example Computer System

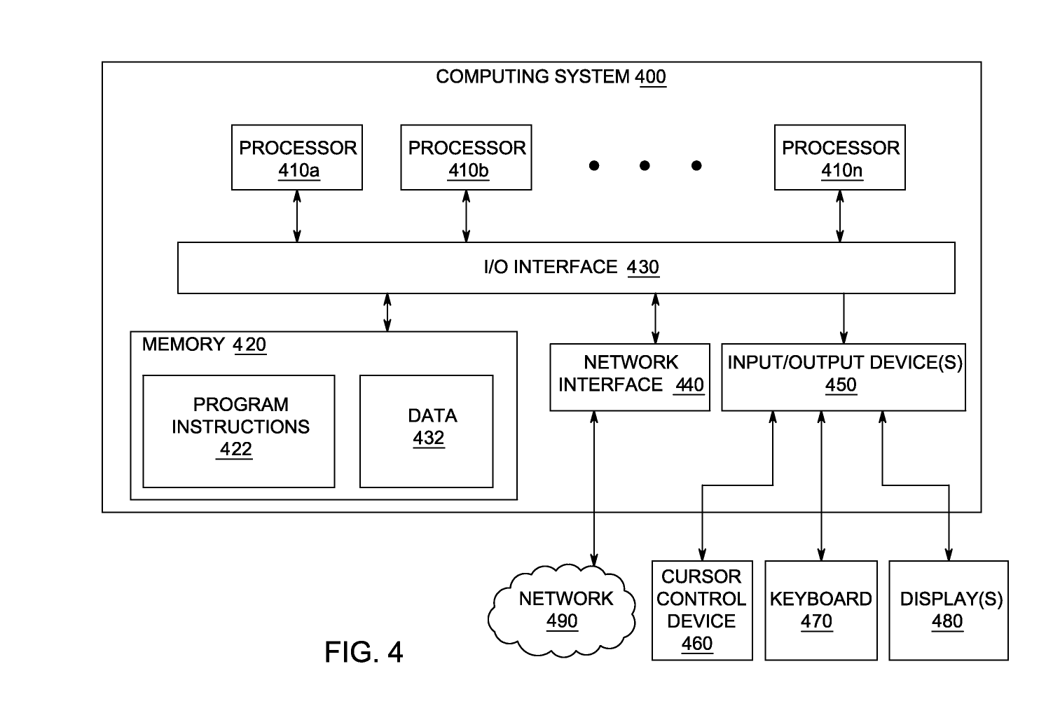

FIG. 4 depicts a computer system that can be utilized in various embodiments of the present invention, according to one or more embodiments.

Various embodiments of an apparatus and method for retrieving objects from an object graph in a content repository based on specified properties and/or relationships, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement methods 200 and 300, as processor-executable executable program instructions 422 (e.g., program instructions executable by processor(s) 410a-n) in various embodiments.

In the illustrated embodiment, computer system 400 includes one or more processors 410a-n coupled to a system memory 420 via an input/output (I/O) interface 430. The computer system 400 further includes a network interface 440 coupled to I/O interface 430, and one or more input/output devices 450, such as cursor control device 460, keyboard 470, and display(s) 480. In various embodiments, any of components may be utilized by the system to receive user input described above. In various embodiments, a user interface (e.g., user interface) may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410a-n may be any suitable processor capable of executing instructions. For example, in various embodiments processors 410 may be general-purpose or embedded processors implementing any of a variety of instruction set architectures (ISAs), such as the x96, PowerPC, SPARC, or MIPS ISAs, or any other suitable ISA. In multiprocessor systems, each of processors 410a-n may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one components (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the methods illustrated by the flowchart of FIGS. 2 and 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for dynamic filtering of an object graph in a content repository, the method comprising:
accessing a plurality of objects in an object graph of a content repository;
forming a request using at least one filtering expression, wherein the filtering expression is used to perform an operation on a selected subset of objects in the object graph; and
executing the request on the selected subset of objects, using the at least one filtering expression.

2. The method of claim 1, wherein the filtering expression is a XPATH style expression constructed using the Extensible Markup Language (XML) Path (XPATH) Language.

3. The method of claim 1, wherein the filtering expression defines performing the operation on at least one of at least one property of the object, all properties of the object, or a complete object graph.

4. The method of claim 1, wherein the operation is at least one of a create, an update, or a retrieve operation.

5. The method of claim 1, wherein the filtering expression specifies a relationship path between a source object and a target object for retrieving a related object from the content repository.

6. The method of claim 5, wherein the relationship path includes at least one of a direct relationship, a transitive relationship or a recursive relationship.

7. The method of claim 6, wherein the filtering expression finds a relationship based on the filtering expression comprises controlling retrieval of the relationship.

8. An apparatus for dynamic filtering of an object graph in a content repository, the apparatus comprising:
a content repository; and
an object management module for
forming a request using at least one filtering expression, wherein the at least one filtering expression is used to perform an operation on a selected subset of objects in an object graph; and
executing the request on the selected subset of objects, using the at least one filtering expression.

9. The apparatus of claim 8, wherein the object management module defines the at least one filtering expression as a XPATH style expression constructed using the Extensible Markup Language (XML) Path (XPATH) Language.

10. The apparatus of claim 8, wherein the object management module defines performing the operation on at least one of at least one property of the object, all properties of the object, or a complete object graph.

11. The apparatus of claim 8, wherein the operation is at least one of a create, update or retrieve operation.

12. The apparatus of claim 8, wherein the object management module defines the filtering expression so as to specify a relationship path between a source object and a target object for retrieving a related object from the content repository.

13. The apparatus of claim 12, wherein the relationship includes at least one of a direct relationship, a transitive relationship or a recursive relationship.

14. A computer readable medium for storing executable code that, when executed by a processor, causes the processor to perform a method, for dynamic filtering of an object graph in a content repository, the method comprising:
accessing a plurality of objects in an object graph of a content repository;
forming a request based on at least one filtering expression, wherein the filtering expression is used to perform an operation on a selected subset of objects in the object graph; and
executing the request on the selected subset of objects in the content repository, using the at least one filtering expression.

15. The computer readable medium of claim 14, wherein the filtering expression is a XPATH style expression constructed using the Extensible Markup Language (XML) Path (XPATH) Language.

16. The computer readable medium of claim 14, wherein the filtering expression dynamically filters properties on which to perform the operation.

17. The computer readable medium of claim 14, wherein the at least one operation is at least one of a create, an update or a retrieve operation.

18. The computer readable medium of claim 14, wherein the filtering expression specifies a relationship path between at least one of a source object and a target object, and a filter on a related object for accessing the relationship path between the source object and target object.

19. The computer readable medium of claim 18, wherein the relationship path includes at least one of a direct relationship, a transitive relationship and a recursive relationship.

20. The computer readable medium of claim 19, wherein finding the relationship based on the expression comprises controlling retrieval of the relationship.
